(19) United States
(12) Patent Application Publication
(10) Pub. No.: US 2012/0060656 A1
(43) Pub. Date: Mar. 15, 2012

(54) Dual Drive Hexagonal Bit

(75) Inventor: Wen-lung Chang, Burlingame, CA (US)

(73) Assignee: Lisle Corporation, Clarinda, IA (US)

(21) Appl. No.: 13/109,771

(22) Filed: May 17, 2011

Related U.S. Application Data
(60) Provisional application No. 61/381,246, filed on Sep. 9, 2010.

(51) Int. Cl. B25B 23/00; B25H 3/00; B25B 15/00

(52) U.S. Cl. 81/438; 81/439; 206/377

(57) ABSTRACT

A dual drive bit is formed as an integral body which includes a drive end which is shaped and configured for engagement with a fastener and an opposite driven end. The driven end includes an internal socket and an external, shaped surface enabling the drive bit to be driven by engaging the internal socket by a socket drive or externally by a wrench. Intermediate the drive end and the driven end is an intermediate or medial section of the body which includes a flange that extends at least in part radially beyond the circumference of the driven end to enable a user to positively engage the driven end and force it axially into engagement with a fastener.

### A RELATED APPLICATION

This is a utility application incorporating by reference and claiming priority to previously filed and co-pending provisional patent application Ser. No. 61/381,246 filed Sep. 9, 2010 entitled Dual Drive Hexagonal Bit.

### BACKGROUND OF THE INVENTION

In a principal aspect the present invention relates to a tool bit construction and, more particularly, to the drive arrangement for such a bit. A plurality of such bits may be provided in a form of a kit.

Variously sized bits are available for use with drives, such as socket drives, for the purpose of attaching or removing fasteners. Typically such bits are provided in the form of a kit which includes various sizes of drive bits. The drive bits may also have various configurations such as hexagonal, square, Torx and other configurations.

A problem that may be observed with respect to such drive bits is associated with the ease of maintaining the bit in contact with the fastener that is being driven or removed. Thus it is necessary to typically provide an axial force on the bit in order to maintain it adequately engaged with the fastener or item that is being manipulated by the bit.

Another factor involving drive bits concerns the mechanism, device or means used to actuate the driven end of the bit. Often a socket drive is provided. On other occasions an external shaped face or configuration is provided which enables the drive bit to be driven by means of a wrench, pliers or similar tool.

While such drive bits are useful, nonetheless improvements therein may enable an improved universality and ease of usage of such bits.

### SUMMARY OF THE INVENTION

Briefly the present invention comprises a drive bit having a driven end and a configured drive end. The drive end of the bit may be in the form of a hexagonal bit. However other drive end configurations may be incorporated in the invention. The driven end of the bit includes an internal socket extending axially in the direction of the longitudinal axis of the bit body or construction and an external configured outside surface typically in the form of a hexagonal driven end. The external hexagonal driven end and the internal socket of the driven end are coaxial with each other and with the drive end of the bit. The driven end and the drive end are formed in a single body separated by an intermediate section which includes an external ledge, flange or projection extending generally outwardly from the periphery of the driven end. The ledge or flange on the intermediate or mid-section of the body acts as a stop when using the external driven end outer surface as a means for operating the bit. The driven end may, for example, be actuated by means of a wrench fitted around or against the external surface. The flange enables placement of pressure by the wrench or similar tool against the flange and thus the bit to ensure that the drive end is adequately engaged or seated with a fastener or other item. As an alternate, of course, the internal socket at the driven end may be utilized to provide a means by which the internal bottom surface of the socket at the driven end may be engaged and physically, axially driven so that the drive bit at the drive end will properly engage or seat on a fastener or the like. The device is especially useful for accessing fasteners in confined areas and enables the user of a single bit to employ either a wrench or socket in such confined areas.

Thus it is an object of the invention to provide an improved bit construction having a dual drive capability.

A further object of the invention is to provide a drive bit which is especially useful in confined areas and may enable enhance access when engaging fasteners and the like.

Another object of the invention is to provide a drive bit which is rugged, easy to use, inexpensive and having a design which will enable incorporation of various types and shapes of drive ends and driven ends for a bit.

Yet another object is to provide a kit of drive bits having multiple sized and shaped drive ends and capable of having socket driven ends as well as shaped external surfaces driven ends.

A further object of the invention is to provide a drive bit capable of having a uniquely configured drive end and a standard or a unique driven end wherein the driven ends is capable of both an internal as well as external drive feature in a single bit.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is a side elevation of a typical bit incorporating features of the invention;

FIG. 2 is a side elevation of the drive end of the bit of FIG. 1;

FIG. 3 is a end elevation of the driven of the bit of FIG. 1;

FIG. 4 an isometric view of the drive bit of FIG. 1;

FIG. 5 is an isometric view of a bit in combination with various drives such as a socket drive and a wrench; and

FIG. 6 is an elevation view of a kit comprised of a multiple number of drive bits having various sizes.

### DESCRIPTION OF EMBODIMENTS OF THE INVENTION

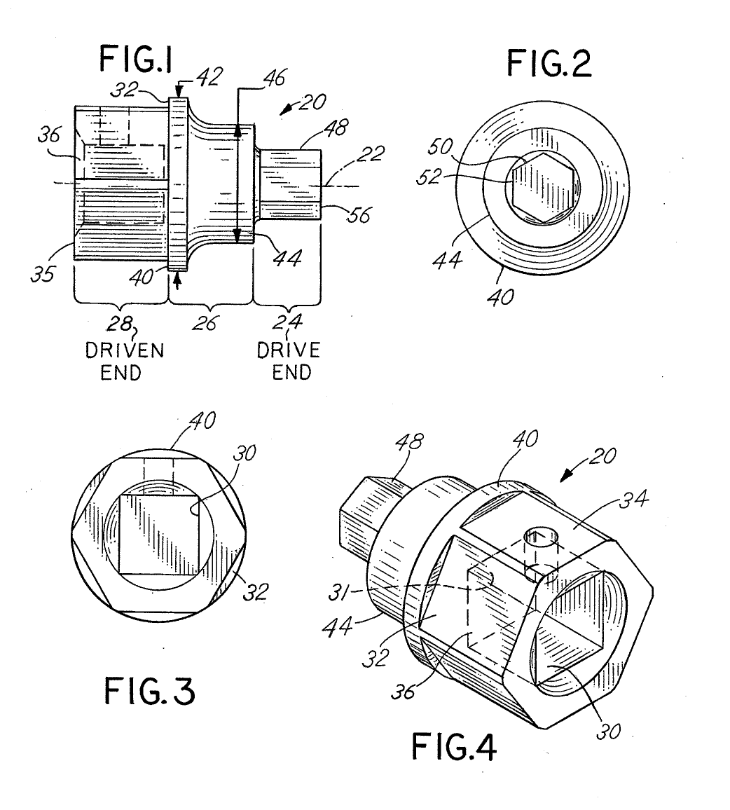

Referring to the Figures, the construction of the bit is described hereinafter in the context of a single bit size and drive configuration. However, multiple bit sizes and drive configurations are within the scope of the invention and multiple bits can comprise a kit as discussed hereinafter. The initial description therefore, shall be directed to the subject matter of FIGS. 1-4 which illustrate a typical bit within the scope of the invention and comprising an embodiment thereof.

Referring therefore to FIGS. 1-4, a single bit is comprised of a unitary body 20, typically cast or formed by forging, machining or other applicable means. For example, rod stock may be cut to a desired length and then formed by forging or other operations including machining operations.

The bit construction of FIGS. 1-4 unitary, integral body 20 is generally elongate and includes a centerline axis 22. The body 20 is divided into three integral, joined sections including a drive end 24, an intermediate connecting section 26, and a driven end 28. The drive end 24, intermediate connecting section 26, and driven end 28 are generally symmetrical with respect to the elongate, centerline axis 22.

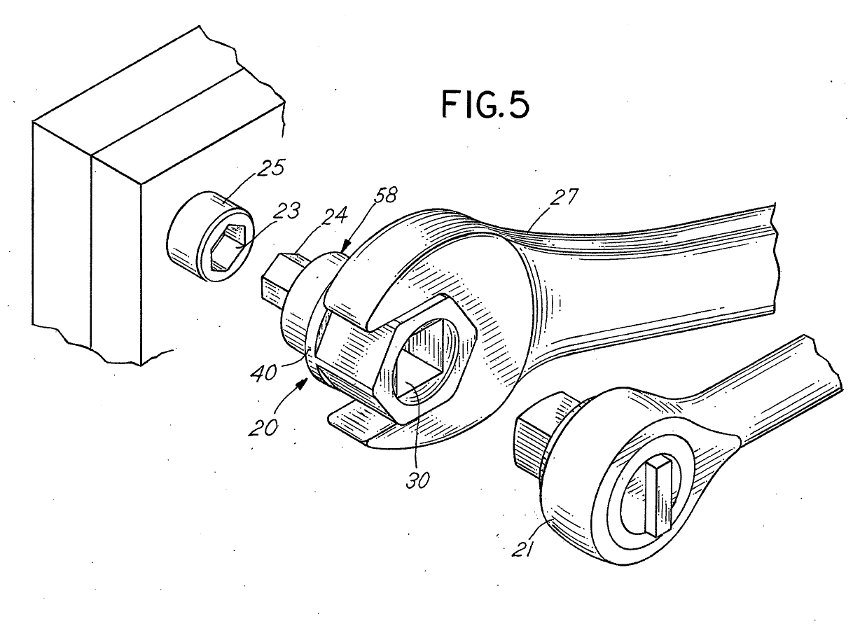

The drive end 24 includes an axial dimension and adjoins the intermediate connecting section 26 also having an axial dimension which may be or may not be lesser than the axial dimension of the drive end 24 depending upon aspects such as the drive means, bit size, tool size, etc. The driven end 28 is typically formed to include a recessed, formed drive socket 30 which is typically a square drive socket symmetrical about the centerline axis 22. The internal socket 30 is formed in the manner which is coaxial with a circumferential outer drive surface 32 which is typically comprised of a series of drive faces such as faces 34 and 36 which are configured, for example, to have a hexagonal cross section which is symmetrical about the centerline axis 22. The axial dimension of the drive socket 30 and the hexagonal outer drive surface 32 is generally substantially the same. That is, the drive socket 30 extends inwardly to a bottom surface 31 of the socket 30 generally aligned with the intermediate connecting section 26 for a dimension substantially equal to the axial dimension of the hexagonal drive surface 32. Thus the bit may be driven by engaging a socket drive 21 in FIG. 5 with the square drive socket 30 or alternatively with a hexagonal wrench or hexagonal drive which 20 may be engaged with the external hexagonal drive surface 32.

The outer surface of the driven end 28 is limited by and connects to a transverse first flange 40 which typically is circular and has a first diameter 42 which is greater than the maximum transverse dimension of the hexagonal drive surface 32. Thus the first flange 40 serves as a means to limit the axial engagement of a hexagonal wrench or similar drive for engaging and turning the bit or body 20.

The intermediate connecting section 26 further includes a spaced second flange 44 parallel to the first flange 40, spaced therefrom and also transverse to the centerline axis 22. The second flange surface 44 is likewise a circular outside diameter flange and includes and/or is defined by a second diameter 46. The second diameter 46 is typically less than the first diameter 42 although this is not necessarily a limiting feature of the invention.

The drive end 24 comprises an external formed hexagonal cross section drive bit 48 which is comprised of a series of surfaces such as surfaces 50 and 52 having the form of a regular hexagon in transverse cross section to the centerline axis 22. The drive end 24 terminates with an outer flange or surface 56 which likewise is transverse to the centerline axis 22. Surface 56 is parallel to the first flange 40 and the second flange 44 as well as a drive end flange 35 of the driven end 28. The various forms comprising the socket 30, the hexagonal drive surface 32 and the hexagonal cross section driven end 48 are all regular geometric configurations and are all coaxial. However, various configurations may be utilized not necessarily having a symmetrical or regular cross-sectional shape.

FIG. 5 illustrates an isometric view the use of a bit 58 of the type as set forth in FIGS. 1-4. Bit 58 includes a drive end 24 designed to engage a compatible opening 23 of a fastener 25. A wrench 27 is fitted over the driven end 28 or engaged by a socket drive 21 fitted in the square socket opening 30. Note that the flange 40 provides a stop for engagement by the wrench 27.

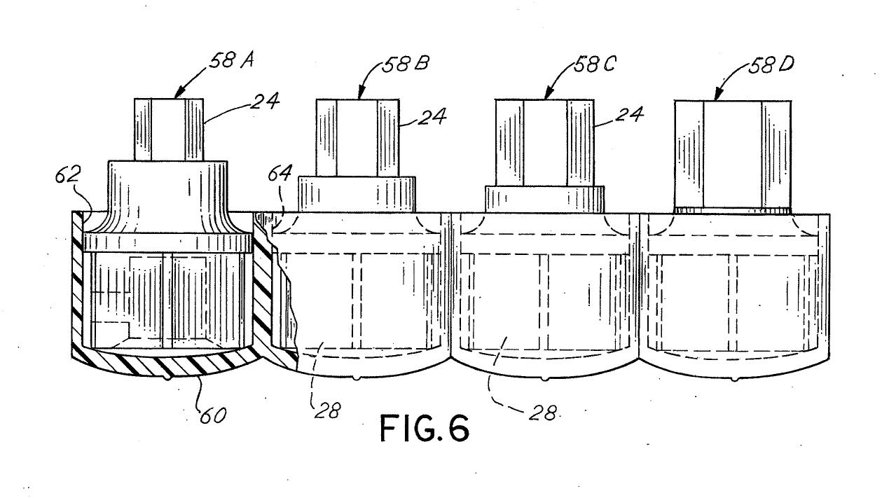

As illustrated in FIG. 6, for example, a series of bits 58A, 58B, 58C, 58D may be provided wherein the driven end 28 is substantially identical with respect to each bit and the drive end 24 is customized to conform to a particular or standard configuration and/or shape and size. Thus a set of bits each having a uniform driven end 28 and separately sized drive ends 24 may comprise a kit of the embodiment depicted. Of course, the particular configuration of the drive end 24 as well as the driven end 28 may be adjusted depending upon the design of the bit. For example, the drive end 24 may have a square outside configuration, a customized “Torx” configuration or any other desired configuration. The same is true with respect to the configuration of the socket 30 as well as the external drive surface 32.

Referring to FIG. 6, in the embodiment depicted, the driven end 28 for each bit is equal in size and shape despite the size of the drive end 24. A convenient way of storing and packaging the bits of the invention is thus to provide a molded plastic bit holder 60 which includes a series of molded pockets such as pockets 62 and 64 which each receive the driven end 28 of each bit. The drive end 24 of the bit may then be marked with the particular size of the bit for ease of identification of the bits. The driven end 28 may also be color coded or the size stamped thereon or other means may be utilized to identify the size of the drive end 24 of the bit.

An alternative construction for the kit would include various recess openings 62 and 64, by way of example, sized to characterize different sizes of the drive end of the bit. Again the bits may be color coded and coordinated in color with the bit holder such as depicted in FIG. 6.

The construction of the intermediate connecting section 26 incorporates the flanges 40, 44. The second flange 44 has a diameter which is typically greater than the maximum lateral dimension of the hexagonal cross section or other cross sectional portion defined the bit drive end 24. The axial dimensions of drive end 24 and driven end 28 are sufficient respectively to enable drive end 24 and driven end 28 to engage a fastener or be engaged by a tool. As a consequence, adequate axial dimensions of the respective sections of the bits become a desirable feature of the invention.

Variations are within the scope of the invention. For example, the body 20 is an integral element. However, the various sections may be separately constructed and joined together by threaded connections or other joinder techniques. Thus a kit could include an intermediate section which capable of coupling with various drive sections and/or driven sections.

Thus while there has been set forth an embodiment and embodiments of the invention, it is to be understood that the invention is limited only by the claims and equivalents thereof.

What is claimed is:

1. A dual drive bit comprising a body having a drive end section and a driven end section, said body further including a centerline axis extending between the driven end section and drive end section;
said body driven end section including a recessed socket having an axial depth within the driven end for receipt of a socket drive, said driven end further including an external drive surface including a plurality of drive faces, said external drive surface having a configuration transverse to the axis, said socket and external drive surface generally coaxially aligned and said external drive surface having an axial dimension to provide for engagement with a drive tool;
said body further including an intermediate axially extending connecting section joined to the drive section and the driven section intermediate said drive and driven sections, said intermediate connecting section including a first flange surface transverse to the axis, at a first junction of the driven end section and the intermediate connecting section, said first flange extending at least in part circumferentially beyond the maximum extent of the geometrically configured external drive surface of the driven end;
said bit further including a drive end section extending from a second junction of the intermediate connecting section and said drive end section, said drive end section comprised of an external surface in the form of a fastener configuration generally coaxial with the centerline axis and extending generally from the intermediate connecting section second junction of the body,
said intermediate section further including a second flange surface at the second junction normal to the axis, all of the flange surface faces of said socket and configuration sections of said bit being generally coaxial.

2. The bit of claim 1 wherein the driven end socket is generally square in cross section and the driven end external configuration is generally hexagonal in cross section and further wherein the drive end section of the body is generally in the form of a hexagon in cross section.

3. A plurality of bits as set forth in claim 1 wherein each bit has a uniquely sized drive end, said plurality forming a kit.

4. The combination of claim 3 in combination with a kit holder in the form of a molded plastic retainer including the plurality of axially aligned pockets for receipt of the driven end of a bit.

5. The bit of claim 1 wherein the first flange surface is perpendicular to the centerline axis of the intermediate body section adjacent the driven end section, is circular and has a diameter greater than the maximum transverse dimension of the body section driven end.

6. The bit of claim 1 wherein the first flange surface and the second flange surface are each circular.

7. The bit of claim 6 wherein the diameter of the second flange surface is less than the diameter of the first flange surface.
